(19) United States
(12) Patent Application Publication
(10) Pub. No.: US 2015/0096892 A1
(43) Pub. Date: Apr. 9, 2015

(54) METHOD AND APPARATUS TO MEASURE BLOOD THICKNESS LEVEL AND BLOOD CONSTITUENT CONCENTRATION

(71) Applicants: Fahim U. Mobin, Orefield, PA (US); Irfan A. Mobin, Orefield, PA (US)

(72) Inventors: Fahim U. Mobin, Orefield, PA (US); Irfan A. Mobin, Orefield, PA (US)

(21) Appl. No.: 14/045,769

(22) Filed: Oct. 3, 2013

(51) Int. Cl. G01N 27/447

(52) U.S. Cl. CPC G01N 27/447
USPC 204/546; 204/641

(57) ABSTRACT

In described embodiment a method and an apparatus are provided for blood characterization. A closed loop electrical circuit employs as part of the circuit, a time varying resistive path that is made out of blood constituents and other chemicals. As the blood characteristics are changing, the resistance of the electrical path is also changing. The resistance change over a predefined time window is used to determine the blood thickness information. The resistance value change over another predefined time window is used to determine the blood density information. Presence as well as absence of blood constituents is determined from the resistance change over a pre-defined time window.

### CROSS-REFERENCE TO RELATED APPLICATION

This application claims the benefit of the filing date of U.S. provisional application No. 61/744,945, filed on Oct. 5, 2012, the teachings of which are incorporated herein by reference.

### FIELD OF THE INVENTION

The present invention relates to identifying concentrations of certain components found in blood in order to determine surpluses and deficiencies through electrical and biochemical techniques. The present invention addresses a method and apparatus for detecting blood thickness or thinness levels that are necessary to know for people who are administered anticoagulant medications in order to manage the risks of heart attack or strokes. In addition, it also provides a means for quantitatively identifying the concentrations of individual blood constituents: the quantitative measurement of the concentrations of blood constituents is vital for health management purposes, for it enables the detections in any deficits in blood composition that may be detrimental to the health of patients by compromising full functionality of body systems. Maintenance and detection of blood thickness level is another key health management element. The quantitative measurement of the concentrations of blood constituents is vital for health management purposes.

### BACKGROUND OF THE INVENTION

The blood clotting phenomenon is a process mainly involving platelets, fibrin (a webby and mesh like substance that is chemically formed when bleeding occurs), clotting factors, normal cells and anticoagulants. The platelets, fibrin, normal cells and clotting factors work to create blood clots while the anticoagulants work to prevent blood clots. We use thick blood to indicate faster blood clotting and we use thin blood to indicate slower blood clotting.

In healthy and normal blood streams, anticoagulants prevail and do not allow the formation of blood clots. In the event of cut or ulcer, the platelets, fibrin, and clotting factors work in conjunction to repair the tissue damage. Platelets in general adhere to rough surfaces. In the event of a cut or ulcer the break in the tissue activates clotting process. Platelets are activated, and stick to the jagged ends of the cut and conglomerate together to stop blood cells from escaping. However, the platelets alone cannot hold together for a long period of time without the aid of clotting factors, which move to the platelets. They interact with fibrin subunits (monomers of fibrin), and polymerize into a fibrin web, which reinforce the clot. Other blood cells like red and white blood cells can get caught in this web, making the clot stronger. The web pulls together the ruptured wall and holds it together until the tissue has been repaired. Plasmin molecules are attracted to the fibrin net, and destroy it through a process called fibrinolysis. The remains are then consumed by phagocytosis, by macrophages and eosinophils.

Because of the importance of clotting, fibrin subunits, platelets and clotting factors are always present in the blood, existing in equilibrium to avoid random clotting. This equilibrium changes in the event of a cut or ulcer, and the process described above then takes precedence. In the event of this balance losing its equilibrium, blood clotting in blood vessels and other organs will occur, even if there are no cuts or ulcers, therefore it is necessary to take blood thinning medications to stop blood clotting. However, excessive use of blood thinners can be life threatening condition in the event of an internal or external cut. This makes it necessary to monitor blood thinning levels often and on a routine basis.

Currently blood clot testing machines use expensive techniques, and are not suited for mass production scale use.

Contemporary methods of determining component deficiencies in blood are relatively expensive. As a result, cost conscious patients are more likely to avoid getting tested for many conditions, resulting in grave dangers to their health. Additionally countries cannot afford to test patients on a mass scale for many of these conditions leading to unnecessary deaths due to commonly treatable conditions. A cheap and accurate method of determining the concentrations of blood component is needed in order to prevent these superfluous deaths. This invention works to solve this problem.

In order to reduce the risk of heart attacks, strokes, and blockages in arteries and veins, blood-thinning medications are administered to prevent the formation of blood clots in the blood stream's pathway. There are several types of blood thinners. One kind of medication commonly known as an anticoagulant, an umbrella term for drugs such as heparin or warfarin. Anticoagulents do not actually thin blood; rather they chemically lengthen the time it takes to form blood clots and/or prevent any further blood clots by inhibiting the formation of the fibrin web that traps sticky platelets. Another kind of blood thinning medicine is known as an antiplatelet, including drugs such as aspirin, which prevent platelets from clumping together to form clots. These blood thinners are generally prescribed for long term care following certain procedures or to determine atrial fibrillation (abnormal heart rhythm), congenital heart defects (structural problem of heart), obesity and family history of heart attack or stroke. Another class of drugs, known as Thrombolytics, break up clots that have already been formed by dissolving the clots.

Excessive dosages of anticoagulants or antiplatelets increase the risks of the failure of the body to stop internal or external bleeding threatening many lives. Currently, a method known as CBC (complete blood count) is used to determine blood cell levels, however, this procedure requires prior knowledge of the individual's condition, frequent visits to the hospital. As a result, there is a need to detect blood-thickness levels in an easy and inexpensive manner.

The present invention addresses a novel, commercial method of detecting the status of blood thickness levels and concentration of blood constituents using a controlled paper chromatography and capillary technique and by measuring the electrical characteristics of the channel created by constituents of blood.

For a detailed discussion of blood coagulation methods discussed above very briefly, see, for example, Textbook of Medical Physiology, ninth edition, by Guyton and Hall (W. B. Saunders Company) and for a detailed discussion of principles of chromatography, see, for example, Principles and Practice of Chromatography (Chrom-Ed Book Series) [Kindle Edition], by Raymond P. W. Scott, see, for example, Principles and Practice of Modern Chromatographic Methods, by Kevin Robards et al (Elsevier Academic Press), and for a detailed discussion of electrical circuits, see, for example, Design of Analog CMOS Integrated Circuits, by Behzad Razavi (McGraw-Hill Higher Education), and for a detailed discussion of circuits and current voltage relationship, see, for example, Electric Circuits, fifth edition, by James W. Nilsson et al (Addison-Wesley Publishing Company), each incorporated by reference herein in their entirety.

### SUMMARY OF THE INVENTION

This summery is provided to introduce a selection of concepts in a simplified form that are further described below in the detailed description with reference to the drawings. This summary is not intended to identify key features or essential features of the claimed subject matter, nor is it intended to limit the scope of the claimed subject matter.

Chromatography is done on filter paper strips, also known as chromatography paper. A solute is placed on a point of origin that is a point which is at a relatively short distance from the bottom of the strip immersed in the solvent in a solvent container. Conductive strips with adjustable intra spacing setting is used; for determining blood thickness increased separation between them is set and decreased intra spacing is set for determining blood constituent concentration.

A method and apparatus for determining blood constituent density incorporates a paper chromatography technique with electrical concepts in order to create an electrical conductive path where the resistance varies as a function of the constituents of the blood. The current flow through this path is monitored over time by creating a circuit consisting of at least a battery, optional resistance to control the current, and a current/voltage measuring meter.

In another embodiment of the present invention a novel method and apparatus is presented for detecting the state of blood thickness levels by measuring the time it takes to create an electrical path with resistance from a first level to a plurality of subsequent level between two or more conductor strips placed on chromatography test strip using suitable solvent.

According to another embodiment of the present invention, the conduction level through the channel created by blood carried by the solvent between the conductors strips placed on chromatography test strip is used to detect blood constituent concentration, such as iron level.

In another embodiment of the present invention blood thickness is measured by monitoring the resistance property of blood as it clots over a pre defined time window.

### BRIEF DESCRIPTION OF THE DRAWINGS

Other aspects, features, and advantages of embodiments of the present invention will become more fully apparent from the following detailed description, the appended claims, and the accompanying drawings in which like reference numerals identify similar or identical elements.

FIG. 1 shows the paper chromatography setup with metal strip connectors for establishing an electrical connection for blood thickness calculation using current measurement;

FIG. 2 shows the paper chromatography setup with metal strip connectors for establishing an electrical connection for blood thickness calculation using voltage measurement;

FIG. 3 shows the time it takes for the solvent end to close the circuit and solute end to close the circuit with solute end lagging the solvent end;

FIG. 4 is a set up to measure blood thickness using chromatography paper with varying base width;

FIG. 5 is a set up to perform quantitative electro-space measurement of blood constituent density;

FIG. 6 shows an exemplary embodiment of the present invention with multiple chromatography strips that uses common electrical and processing resources;

FIG. 7 shows a setup to multiplex solvent end metal conductor strip connector configured for blood thickness measurement and blood constituent density measurement;

FIG. 8 is an exemplary flow chart to measure blood thickness;

FIG. 9 is an exemplary flow chart to measure blood constituent density measurement;

FIG. 10 illustrates options for blood electro chromatography connector strip setup of the invention to achieve electrical information in various ways; and

FIG. 11 illustrates another embodiment of the present invention to measure blood thickness without the use of solvents.

### DETAILED DESCRIPTION

In accordance with exemplary embodiments of the present invention, a blood thickness measurement, blood component concentration measurement, incorporates a paper chromatography technique with electrical concepts in order to create an electrical conductive path where the resistance varies as a function of the constituents and characteristics of the blood. The current flow through this path is monitored over time by creating a circuit consisting of at least a battery, optional resistance to control the current, and a current or voltage measuring unit. The resistance change in a blood during blood clotting process over a time window is used for blood thickness measurement.

Embodiments of the present invention provides following advantages. An inexpensive blood thickness as well as blood density measurement method and apparatus for timely adjustment of medication to maintain appropriate blood thickness. An inexpensive blood component concentration measurement method and apparatus for timely detection of physiological problems, such as low iron count in anemic condition, as an example.

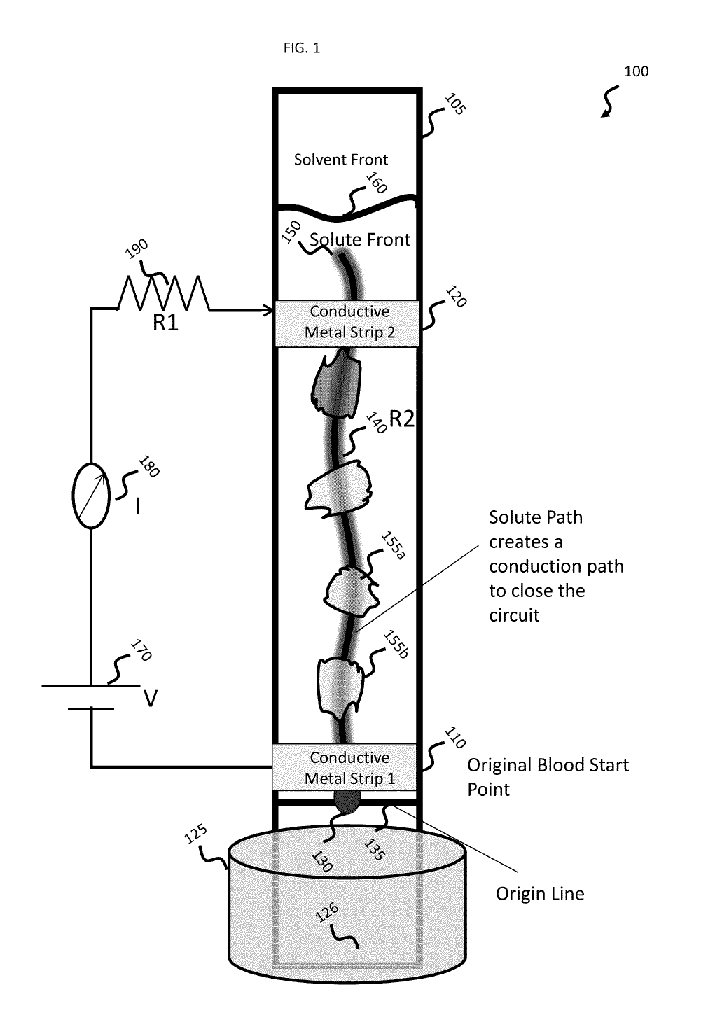

FIG. 1 shows an exemplary operation of blood thickness measurement 100 in accordance with an exemplary embodiment of the present invention using current measurement. A fibrous material such as a chromatography paper 105 having two conductive metal strips 110 and 120 covering parts of the chromatography paper. A specimen, such as a blood sample 130 is placed at location 135, denoted as the point of origin line, or simply the origin line. The solvent container 125 contains solvent 126. The solvent travels up through the chromatography paper and carries the blood specimen mixture components in the form of the mobile phase from 130 with similar polarities at the fastest rate and blood mixture components with dissimilar polarities at lower rates along the path 140. The solvent front 160 travels the fastest through the chromatography paper and the solute front 150 lags the solvent front 160. Based on the polarity dissimilarities between the solvent and the constituents of blood mixture various blood mixture components 155a, 155b, and others are separated at a different rates as the solvent front travels. The specimen 130 at origin line 135 is below the conductive metal strip 110 and as the solute path 140 travels up the conductive metal strip 110 a connection happens between the solute path 140 and metal strip 110. As the solute path 140 crosses above conductive metal strip 2 120, a channel is created 140 between the conductive metal strip 1, 110, and conductive metal strip 2, 120, and the conductivity of the channel 140 depends on the constituents of the blood mixture. The conductivity of the channel 140 is measured by creating a closed circuit electrical path between the two conductive metal strips 110 and 120 by connecting a battery 170 and an optional resistance 190 to limit the maximum current through the closes loop circuit that consists of the blood solute path channel 140 as part of the closed loop circuit. The current through the closed circuit

$${I}_{closedLoop} = \frac{V}{R 1 + R 2}$$

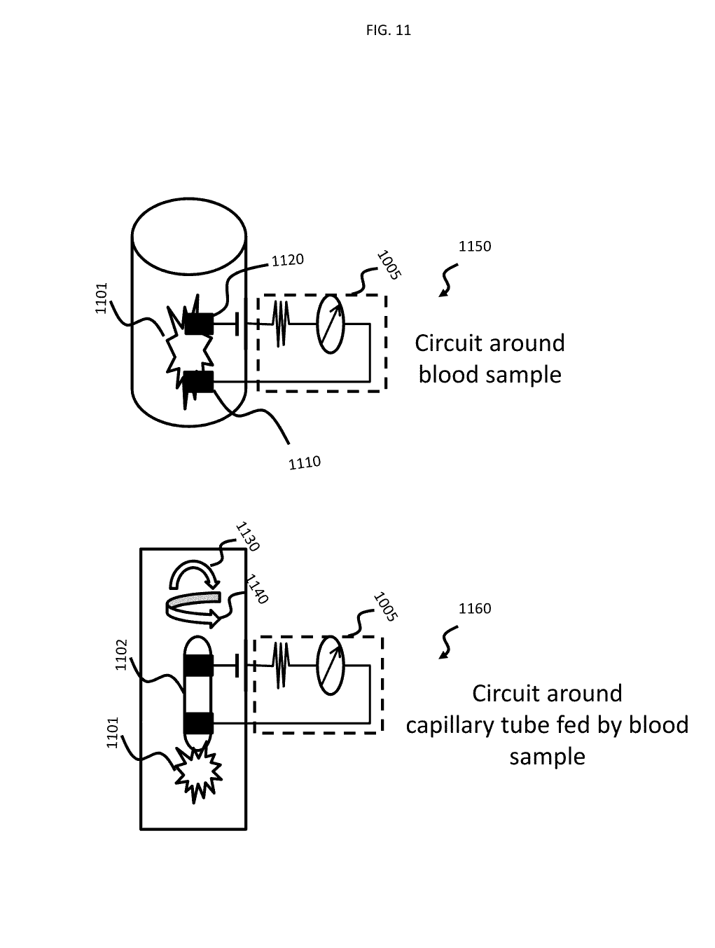

is where R1 is the external current limiting resistance, R2 is the resistance of the solute path, also known as mobile phase path, 140 between metal strips 110 and 120, and V is the voltage of the voltage source. In reality channel 140 will have very high resistance if channel formed by mobile phase 140 does not connect conductive metal strips 110 and 120. The amount of current in the circuit carries the information about blood component concentration. The thinner the blood, used relatively, is the longer it takes to clot, the further the mobile phase will travel and the faster the channel 140 will be formed. Thus the time to form the closed loop electrical circuit carries information about the blood thickness and the amount of current in the closed loop circuit carries the information about the concentration of specific blood components. The blood sample placed on a chromatography paper where the chromatography paper is considered a blood sample receptor that receives blood sample. A receptor is used to accept blood sample, where the receptor is a chromatography paper. In an alternate embodiment of the present invention the receptor is a capillary tube as will be discussed relating to FIG. 11. In one embodiment of the present invention an anticoagulant chemical substance is added to the receptor so that collected blood sample does not clot on the receptor before blood characterization starts. The variable resistance R2 between two electrical contacts is used to create a closed loop electrical circuit by connecting a voltage source across the electrical contacts. To limit circuit current a resistance R1 of suitable value can be added in series with the voltage source. The invention is not limited to the stated circuit configuration. Any alternate circuit scheme falls within the scope of the spirit of the current invention. The closed loop circuit current decreases when the variable resistance is high while the closed loop current increases when variable resistance is low. Current is inversely proportional to the resistance. As a result by monitoring circuit current using a current meter one can determine variable resistance. On the other hand the current flow in the circuit results in voltage drop across any external resistance, R1, or across the variable resistance, R2, such that V=IR relationship holds known to a person skilled in the art, where V is the voltage, I is the current, and R is the resistance. One skilled in the art may formulate alternate scheme to measure variable resistance without limiting the scope and spirit of the current invention; One skilled in the art can choose to do (a) direct calculation of variable resistance from measured current and voltage across variable resistance, or (b) direct measurement of voltage, or (c) direct measurement of current to quantify electrical behavior of the channel 140. For brevity in this specification we use the term electrical quantity, E, to denote any of the above mentioned measured or calculated quantity interchangeably. The variable resistance between two or more electrical contacts changes as the blood constituents passes between said electrical contacts through the chromatography process wherein said blood concentration and electrical properties of blood between said contacts changes over time based on the blood constituents present between two or more contacts. We interchangeably use the term conductive metal strip or electrical contact or contacts in this specification. We use the term solute path and mobile phase interchangeably because these terms mean the same thing.

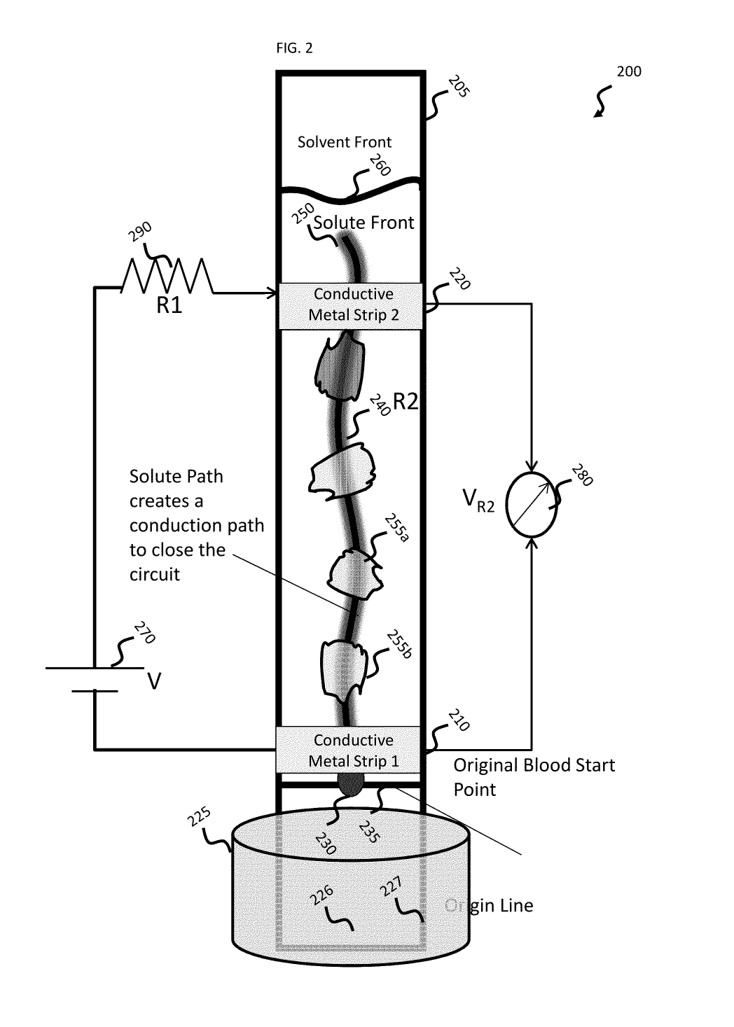

FIG.2 shows exemplary operation of blood thickness measurement 200 in accordance with an exemplary embodiment of the present invention using voltage measurement. A fibrous material such as a chromatography paper 205 that has two conductive metal strips 210 and 220 covering parts of the chromatography paper. A specimen, such as a blood sample 230 is placed at location 235, denoted as the origin line. The solvent container 225 contains solvent 226. The solvent travels up along the chromatography paper in the form of the mobile phase, and carries blood specimen mixture components from 230 with similar polarities at faster rates and blood mixture components with dissimilar polarities at slower rates along the path 240. The solvent front 260 travels the fastest through the chromatography paper and the solute front 250 lags the solvent front 260. Based on the polar dissimilarities of the constituents of blood mixture various blood mixture components 255a, 255b, and others are separated as the solvent front travels. The specimen 230 at the origin line 235 is below the conductive metal strip 210 and as the solute path 240 travels up the conductive metal strip 210 a connection happens between the solute path 240 and metal strip 210. As the solute path 240 crosses above conductive metal strip 220, a channel is created 240 between the conductive metal strip 210, and conductive metal strip 220, and the conductivity of the channel 240 depends on the constituents of the blood mixture. The conductivity of the channel 240 can be measured by creating a closed circuit electrical path between the two conductive metal strips 210 and 220 by connecting a battery 270 and an optional resistance 290 to limit the maximum current through the closes circuit consisting of external circuit and the blood solute path channel 240. The maximum current through the closed circuit is

$$I = \frac{V}{R 1}$$

if R2 is zero. In reality channel 240 will have infinite resistance if channel 240 does not connect conductive metal strips 210 and 220. When the channel 240 connects conductive metal strip 210 and 220 the closed loop circuit is established and the current is given by

$${I}_{closedLoop} = \frac{V}{R 1 + R 2} ,$$

where R1 is the external resistance that can be 0 Ohm to any suitable value to limit the total current flow and R2 is the resistance of the channel 240 that varies with the blood constituents that forms the channel 240. The amount of voltage drop across the channel 240 V_{R2}=I_{closedLoop}*R2 carries the information about blood component concentration. The thinner the blood, the longer it takes to clot and the further the solute front end will travel. The thinner the blood, the slower it clots and the faster it takes to establish the channel 240. Thus the time to form the closed loop electrical circuit carries information about the blood thinness and the amount of voltage V_{R2} in the closed loop circuit across channel 240 carries the information about the concentration of specific blood components. Measurement voltage variation across the conductive metal strips 210 and 220, V_{R2}, is an indication of channel resistance variation or alternately an indication of channel conductance variation. By the use of the comparison of the values of the previous voltage to the new voltage, which affords information about the relative concentrations of blood constituents passing between the conductive strips 210 and 220 the blood constituent density is determined. Mobile phase 240 is striated in a specific order due to the polarities of each blood component; using the quantified value of the change in voltage can be compared to the order of components and the voltage of the individual components to determine which blood component has just passed conductive strips 210 and 220 and that information is used to detect presence as well as absence of any anomalies in blood. Moreover, this voltage can be compared to the time taken for the change in voltages from one level to a subsequent level between a time windows for the determination of blood thickness.

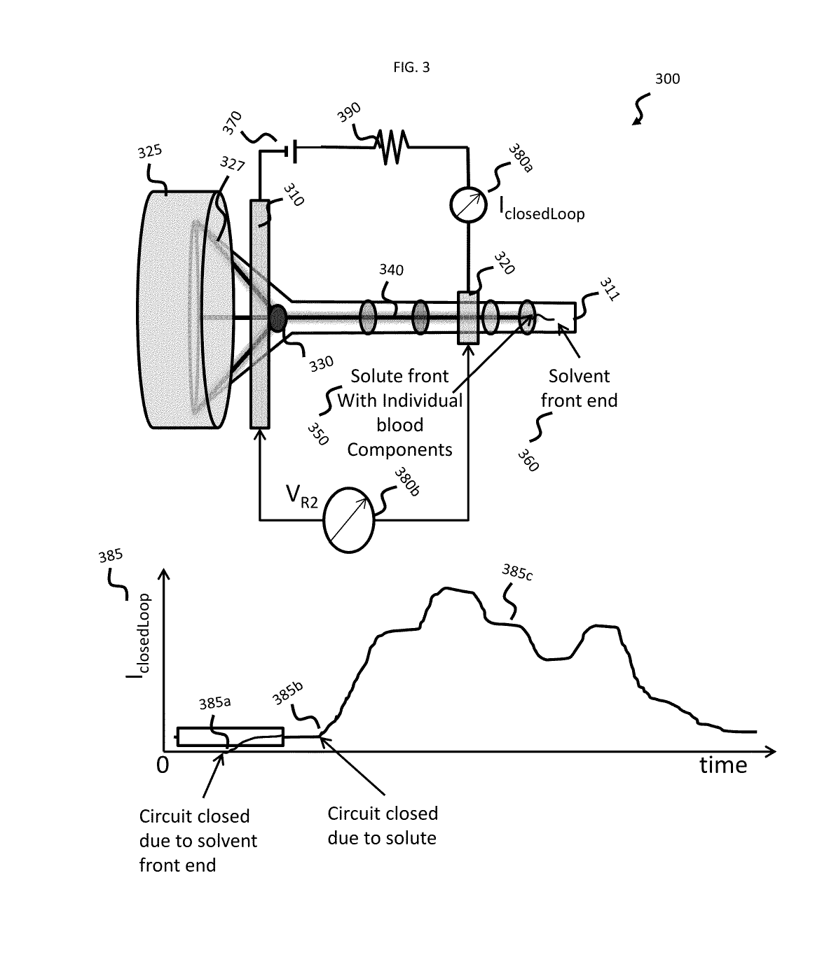

FIG. 3 demonstrates an exemplary mechanism to measure the blood thickness in a quantitative manner, without limiting the scope of the invention. In the exemplary setup 300 the chromatography paper base 327 at solvent container is made wider unlike in FIG. 2 where the chromatography paper base 227 was same between the solvent end to at point of origin 235 and the moving solvent front end 260 at the top. Chromatography paper base 327 at solvent end is adjusted to be wider or narrower with respect to chromatography end at the top 311. Chromatography paper base size 327 is adjusted to optimize the speed of channel length 340 creations controlling the time to establish the closed channel 340 between 310 and 320 conductor strips. A narrow base 327 having a blood sample 330 at point of origin, where the blood sample is placed at the bottom of the chromatography paper at solvent container 325 end, will obstruct solvent front end 360 creation and hence slow down the advancement of the solvent front end 360 and will also slow down the movement of solute front end 350, here blood mixture components are considered solute in this invention without limiting the principle to other solutes. Limited solvent movement through the chromatography paper will lower the spread of front end movement and will take longer time to establish the channel 340 between the conductive metal strip 310 and 320. A wide base 327 having a blood sample 330 at point of origin, where the blood sample is placed at the bottom of the chromatography paper at solvent container 325 end, will have sufficient space for solvent front end 360 creation and hence increase the advancement of the solvent front end 360 and will also increase the movement of solute front end 350, here blood mixture components are considered solute in this invention without limiting the principle to other solutes. Limited solvent movement through the chromatography paper will lower the spread of front end movement and will take longer time to establish the channel 340 between the conductive metal strip 310 and 320. In one embodiment of the present invention the electrical characteristics of the channel 340 created by the solvent and the solute is used quantitatively, by detecting the time it takes to establish an electrical channel 340 between the conductor strips 310 and 320 by the solvent front end and by the blood mixture components separated and travelled through the chromatography paper using the chromatography principle, as a measure of the blood thickness and to quantify the blood constituents. In one embodiment of the present invention, without limiting the scope of the invention, to evaluate the electrical characteristics of the channel 340 an electrical circuit is established by connecting a battery 370 in series with the conductor strip 310, a resistance 390 in series with the battery, optionally a current meter 380a in series with resistor 390, and the conductor strip 320 in series with the current meter 380a if exist or in series with the resistor 390. If current meter 380a exists one can use current characteristics of the channel 340. Alternately one can use the voltage across the conductor strips 310 and 320 as an alternate means. It is understood that current and voltage is related to each other in terms of the resistance in their path and therefore the behavior of the circuit is understood in terms of resistance as well. We will use the terms current, voltage, and resistance interchangeably in this specification because current, voltage, or resistance relationship is known by those skilled in the art without departing from the scope of the invention. At relative time 0s the chromatography paper with blood specimen 330 is submerged up to the origin line 235 shown in FIG. 2 in the solvent container 325. To simplify the explanation and to assist in visualization the electro chromatography setup is rotated clockwise. The solvent end rises through the first conductor strip 310 reading very low current based on the impedance of the chromatography paper. The solvent front 360 continues to rise and after it crosses the second conductor strip 320 a channel is created that is dominated by solvent and some separated blood constituents separated from the 330 specimen. Based on the reduced impedance a noticeable increase in current is observed at 385a. The length of the time 0 to 385a indicates the solvent front end travelling speed through the specific structure of the chromatography paper strip and this time is a baseline time for a specific chromatography strip structure. As the blood constituents continued to get separated and carried by the solvent based on the polarities matching between the solvent and the solute, the channel 340 is now constitutes of a solvent channel and an additional channel based on the blood components between 310 and 320 at time 385b. Clearly at this time the channel 340 impedance is even lower and a noticeable increase in current takes place. As blood mixer composition separation continues based on the contents of the separated mixture components that forms the channel 340 the current varies as the channel impedance varies with the constituents of the separated components of the blood forming the channel. The blood thickness information lies in the length of the time 385a and 385b and their difference for a specific chromatography strip. A complementary view of the above description with current can be drawn by monitoring the voltage 380b across the channel 340 using the basic electrical relationship between current and voltage, V_{R2}=I_{closedLoop}R2, where R2 is the resistance of the channel 340 and

$${I}_{closedLoop} = \frac{V}{R 1 + R 2} .$$

Measurement current variation through current meter 380a, I_{closedLoop}, is an indication of channel resistance variation or alternately an indication of channel conductance variation. As the current changes due to variable resistance in the electrically closed circuit the first appearance of the first level of current and the subsequent appearance of subsequent level of current is due to the state of the substances of the blood that creates the electrical path which is changing its electrical characteristics over time. The time between the first level of current to subsequent level of current is proportional to blood thickness. The first level of current is due to solvent dominated formation of electrical channel and subsequent level of current is due to blood constituents separated by chromatography action. Thin blood will clot at a slower rate and is favorable to chromatography action. The thick blood will clot at a faster rate and not favorable to chromatography action. If the time between first levels of current to the second level of current is shorter from normal blood in the chromatography setup the blood is relatively thin If the time between first levels of current to the second level of current is larger from normal blood in the chromatography setup the blood is relatively thick.

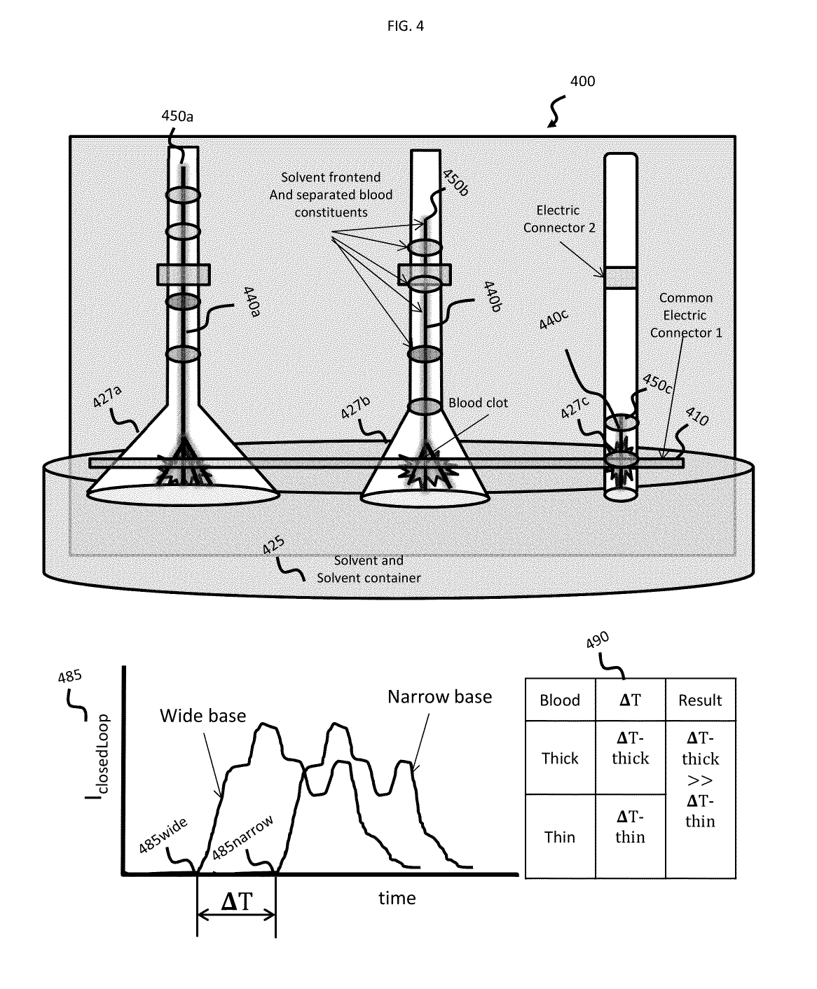

FIG. 4 demonstrates an alternate exemplary mechanism 400 to measure blood thickness where the blood thickness measurement test strip is made by a set of chromatography papers with varying base sizes 427a, 427b, 427c. For brevity the electrical circuit elements, battery, connectors, resistance, discussed earlier is not shown. The test blood drop is set at the point of origin of each test strip slightly above the solvents in the solvent container 425. In case of thin blood the blood clot will form slowly and all individual solute front ends will rise relatively faster along with the solvent front ends. While in case of thick blood the blood clot in narrow base 427c will obstruct the solvent path but the wider base 427a test strip will have free path for the solvent to create relatively longer blood channel 440a compared to relatively shorter blood channel 440c for the barrow base 427c. The disparity in channel length between narrow and wide base test strip is a quantitative measure of the blood thickness. By measuring the initial current time difference of the solute front end between the wide and narrow base one can quantitatively measure the blood thickness level. In case of thick blood the time difference between 485wide and 485 narrow is a large ΔTthick and in case of thin blood the difference between 485wide and 485 narrow is a small ΔTthin and ΔTthick>>Δthin as shown in table 490.

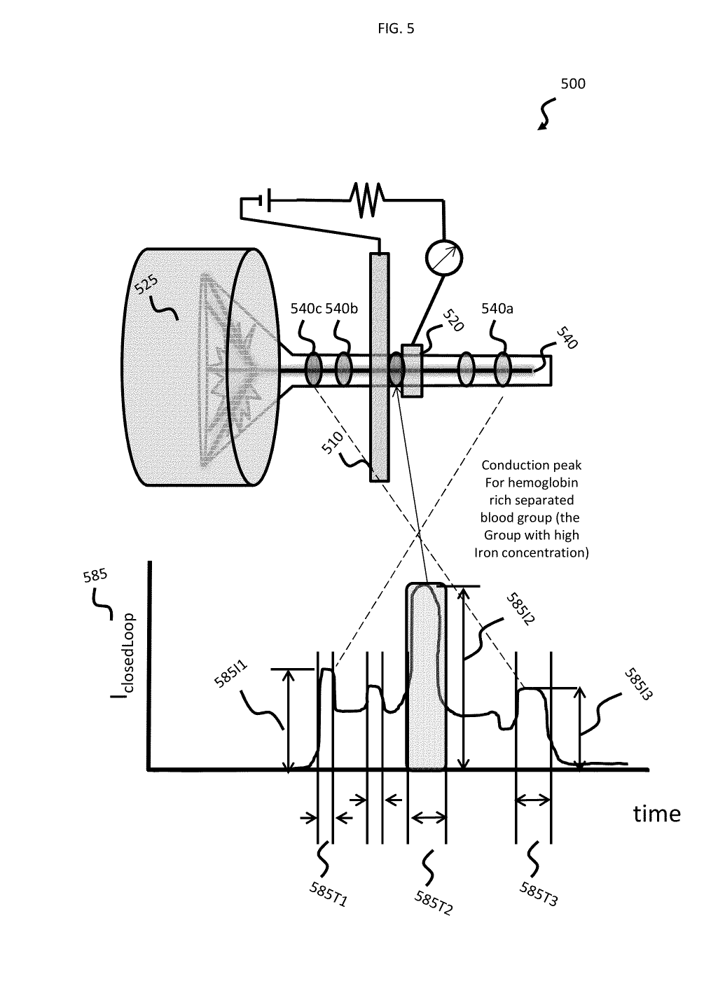

Referring now to FIG. 5, the spacing between the conductive metal strip 510 and 520 is narrowed and a circuit diagram depicting a setup for blood constituent density measurement is shown. Chromatography is a method of breaking apart mixtures based on their components' polarities, with relation to the polarity of the solvent, components with polarities similar to that of the solvent moving at a rate similar to solvent 540a and components with polarity different from the solvent moving at a relatively slower rate 540c. Components with polarities that are different from the solvent's polarity will move at a slower rate. As chromatography separates the blood mixture components, various groups of blood constituents will travel upward at various rates as shown by 540a, b, c, based on their polarity in relation to that with the solvent used. The materials with a polarity similar to the solvent will be at the top (near the solute front) 540a, while those with a greater difference in polarities will be near the origin 540c. They will be separated based on their individual polarities and form bands of the same substance in a stratified fashion. By narrowing the spatial placement of the connectors 510 and 520 one can establish the electric circuit path on a specific target blood constituent group as they travel through the path between the connectors. By measuring the conduction of the current through a specific blood constituent group, one can quantify the concentration of certain constituents of blood. For example by knowing the position of the Hemoglobin band in a chromatography separated blood group, and by knowing the conductive properties of the hemoglobin rich group in normal blood, definitely determine the absolute or relative measure of hemoglobin level in blood for the detection of anemic condition. In other words, the length of time 585T1, 585T2, 585T3, . . . that certain current 585I1, 585I2, 585I3, . . . exists corresponds to the concentration of the component. A preferred base for this measurement would be the chromatography setup with the larger base, but not limiting the scope of this invention. The peak current determines the concentration of the specific component of blood, i.e., hemoglobin as an example in 585I2. It is the duration of this current that determines the spread of the chromatography and it is the peak that determines the intensity of the concentration. The stratification of polarities will always be constant in normal healthy condition, so the order of the peaks already determines which component is being examined for a given mixture. Appearance of new unexpected peak is an indication of possible abnormality. A plurality of differences of said variable resistance sequence offers the detection of presence of new substance or absence of a substance in blood. If a sequence of variable resistance is absent or low the blood is missing or low in a substance compared to normal blood. If a sequence of extra variable resistance is present the blood has additional substance compared to normal blood. The magnitude relationship of said variable resistance with respect to the magnitude of said variable resistance for normal blood offers the relative density information of blood constituents. To improve the isolation of blood constituents and hence get better density measurements of substances of one kind the separation of electrical contacts are decreased.

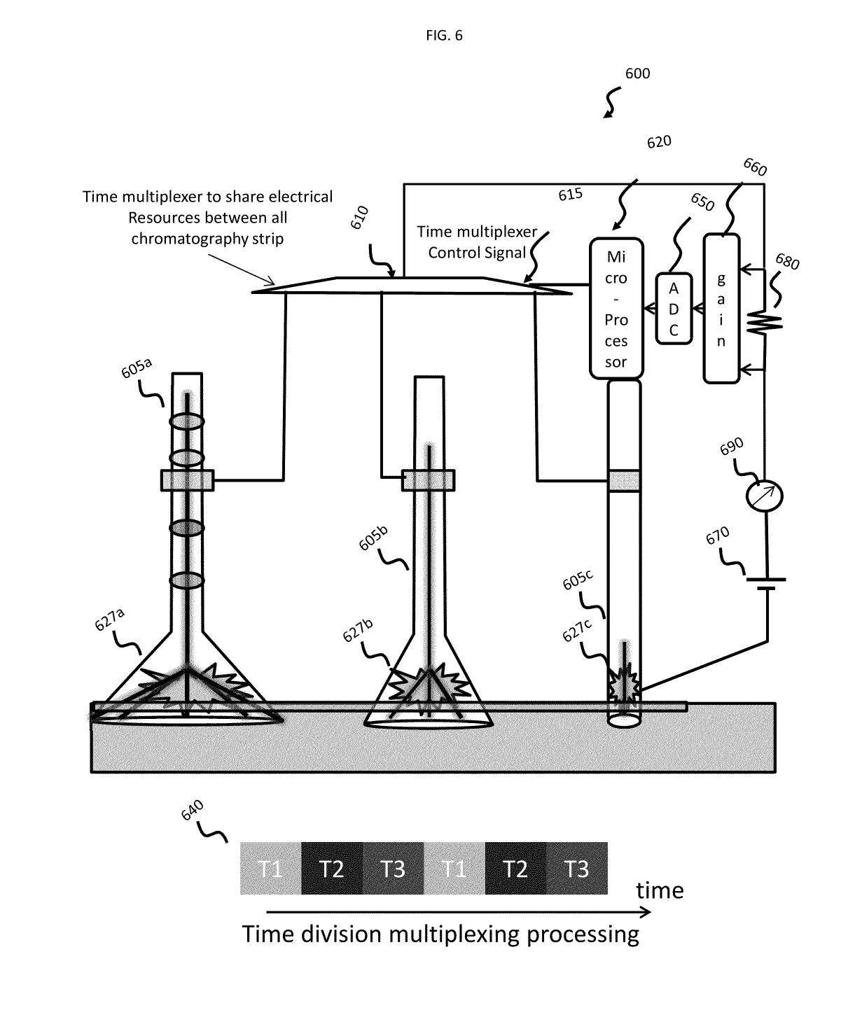

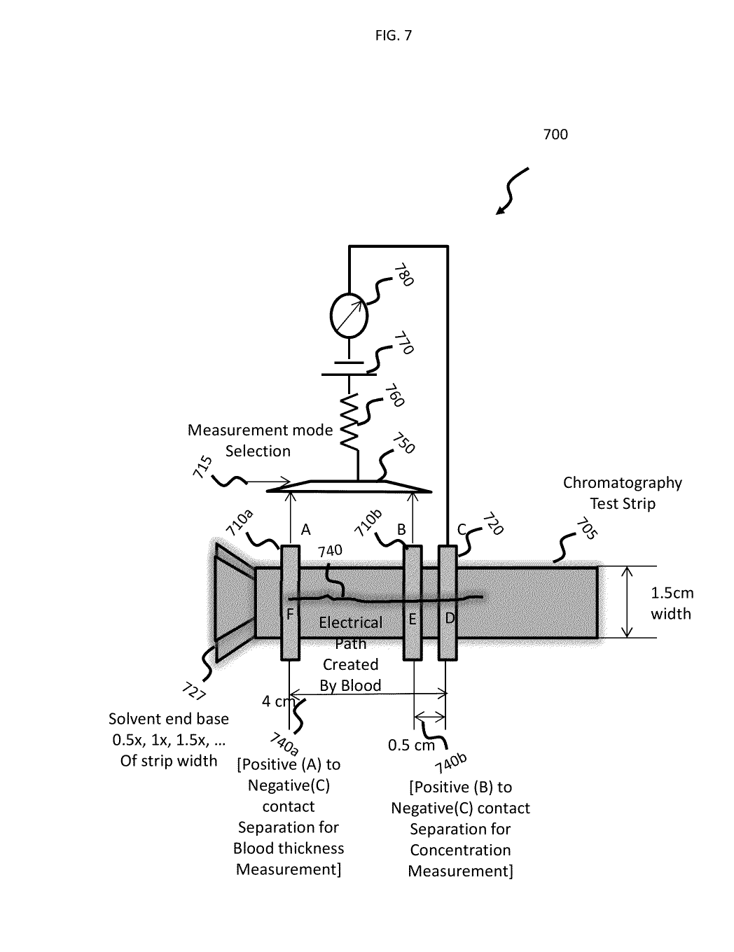

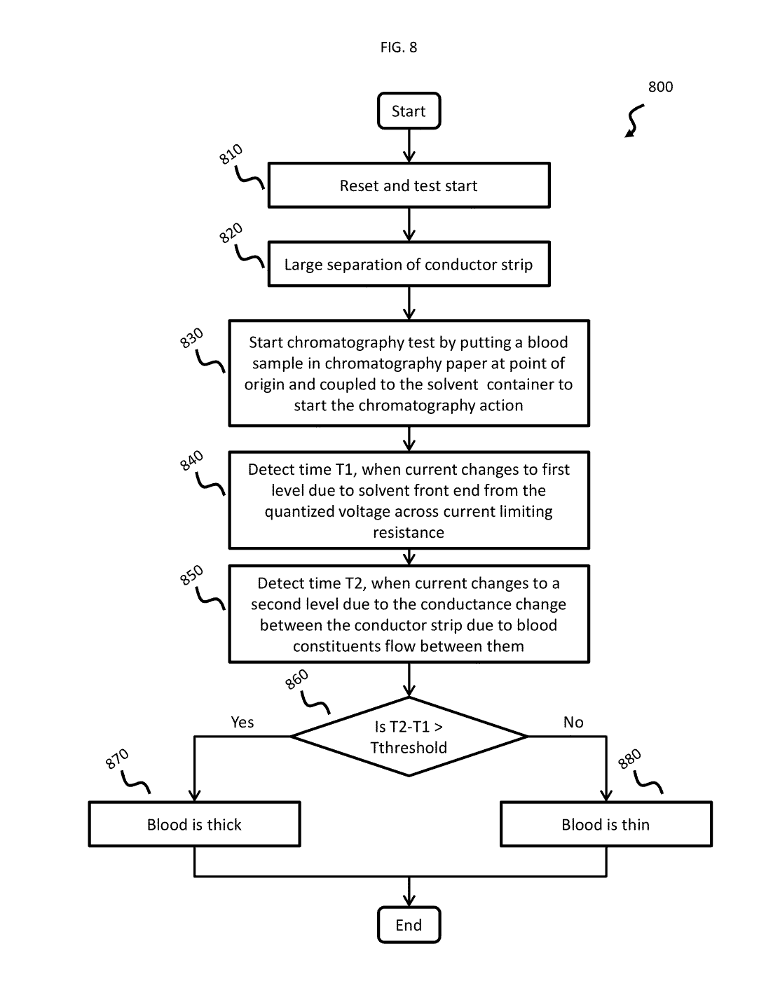

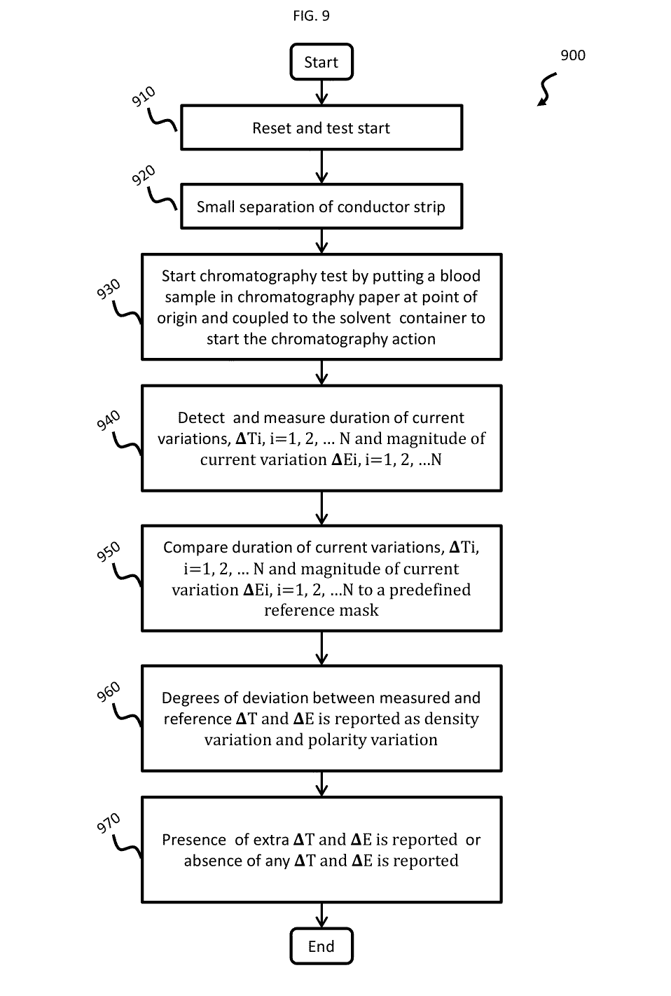

FIG. 6 shows an embodiment of the invention for the realization of the apparatus and steps of determining blood characteristics. In this exemplary system 600 has three chromatography test strips 605a, b, c creating three data sources with varying base widths 627a, b, c. One set of electrical resources, consisting of the battery 670, current meter 690, resistance 680, and a microprocessor 620 to process the voltage across resistor 680 that is amplified by an amplifier denoted as gain block 660, and quantized to digital signal by an analog to digital converter 650 that are shared for all three test strips using an analog multiplexer 610 and the multiplexer port selection 615 that is controlled by a microprocessor 620. The reason for using the voltage across 680 will be clearer from the explanation of FIG. 7 below for the purpose of explanation without limiting the use of current. The quantized voltage from the test strip is processed in the microprocessor in time division multiplexing fashion 640, where in time slot T1 test strip 605a is processed, in time slot T2 test strip 605b is processed, in time slot T3 test strip 605c is processed and then the cycle repeats. In another embodiment of the present invention a digital state machine performs the operations described above by a microprocessor. Fir brevity we use the term processing unit to address a state machine or a microprocessor. The processing unit operates on the digitized data to implement the flow chart explained in relation to FIG. 8, FIG. 9, and FIG. 11 to determine blood thickness, blood constituent density, presence, absence of blood constituents.

FIG. 7 shows an embodiment of the invention configured for measuring blood thickness as well as blood constituents without limiting the scope of the invention. In this embodiment the conductive metal strip 710a close to the base 727 is used for blood thickness measurement and alternately another conductive metal strip 710b that is placed closer to the second conductive metal strip 720 spaced narrowly to measure the blood constituents density, presence, absence of specific blood constituents. Based on the measurement selection 715 either 710a or 710b will be selected for intended measurement. Based on the measurement selection 715 the effective solute channel length 740 is the largest 740a for blood thickness measurement or the smallest 740b for the blood constituent characteristics measurement that includes blood constituent density, presence, absence of certain blood constituents. The chromatography paper base 727 can be of varying with. Larger width will allow larger solvent flow and narrower width will limit solvent flow. The use of a different width offers different rate of solute flow for channel 740 formations and hence offers flexibility in blood characterization.

Returning to FIG. 7, the chromatography segment 740 between the metal contact 710a, b and 720 acts as a time varying resistor. The resistance, inversely denoted as conductance, varies over time based on what substance is passing through said segment. When mostly solvent front end is passing through said segment one type of conductance will be offered based on the electrical characteristics of the solvent. When various constituents of blood flows, based on the polarity of the blood constituents, their density, and their electrical characteristics, a difference amount of conductance will be offered by said segment. The fastest substance that passes through said segment 740 is dominated by the solvent and said dominated solvent offers a specific resistance of the electrical path 740 between 710a,b and 720. A subsequent substance that creates the electrical path 740 consists of various compositions of blood constituents and the solvent and their composition offers a different resistance of the electrical path 740. Thus the electrical path 740 is said to have time varying resistance, alternately stating it has time varying conductance. More resistance will reduce the current flow through the closed loop circuit, where said closed loop circuit consists of the conductive metal strip 710a, b, connected to the chromatography paper, one of which will be selected by the analog multiplexer 750 by the measurement mode selector 715, an optional resistance of value R1 760 to limit the maximum current through the circuit, a voltage source 770, optionally a current meter 780, the second conductive metal strip 720 connected to the chromatography strip, and the electrical path 740 created by the substance that flows between the conductor strips such as solvent and other constituents of the blood compositions. In one embodiment of the present invention, blood characteristics is observed by monitoring the duration and magnitude of the current through the closed loop circuit, where current varies as a function of the amount of blood constituents, density of blood constituents, electrical conductivity of blood constituents, and speed of the substance passing through the electrical channel 740. In another embodiment of the present invention, the blood characteristics is observed by monitoring the voltage drop across the said electrical channel 740 having time varying resistance of value R2. By knowing R1, a relative measure of the current through the closed loop circuit can be obtained by noting the voltage drop across the fixed known resistance R1 as well, where V_{R1}=IR1=R1*V/(R1+R2). Returning to FIG. 6, the microprocessor 620 can use the voltage V_{R1} after it is amplified by gain unit 660 and digitized by the analog to digital converter (ADC) 650. The blood constituent density is measured by decreasing the spacing between at least two electrical contacts so that the separated blood constituents during chromatography action between two contacts are mostly similar. The conductivity of certain blood constituents will dominate the channel 740 resistance. Thus the resistance of channel 740 indicates the density of certain blood constituents. Normal blood has pre-defined blood constituents. An abnormal blood has extra blood constituents, lacks certain blood constituents, or has different density compared to normal blood. During chromatography action as blood constituents are separated and passed between the electrical contacts the time of occurrences of resistance change and their specific values indicates blood density. Appearances of new resistance sequence in blood during chromatography action between two electrical contacts indicate presence of additional extra substance in blood. Absence of a resistance sequence in blood during chromatography action between two electrical contacts indicates absence of certain substance in blood.

FIG. 8 shows an exemplary flow diagram of the blood thickness measurement process 800 without limiting its application scope. At the beginning of the process reset microprocessor initial states 810. Create large separation between the conductor strips 820 that are responsible for creating a closed loop electrical circuit to increase the variable resistance electrical channel length. Start the chromatography test by putting a blood sample in the chromatography paper at the point of origin and couple the chromatography paper with the solvent container by dipping its base end in the solvent to start the chromatography action 830. In one embodiment of the present invention monitor current flow activities in the closed loop circuit by monitoring the voltage drop across the current limiting resistor using scheme described in relations to FIG. 7. Another alternate scheme is to monitor current using a current reader. The electrical information as well can be derived by monitoring the voltage across variable resistance channel 740 described in FIG. 7. A person skilled in the art can use and utilize an option out of various available options to gather the same information in different combination of current-voltage format. From the voltage drop across the current limiting resistance cited above determine time T1, when current, proportional to the voltage drop across current limiting resistance, changes to a first level due to initial solvent front end and like polarity blood constituents 840. Next determine time T2, when current changes to a second level due to the conductance change between the conductor strips due to channel created mostly dominated by blood constituents 850. Determine the time difference between T2 and T1 860. If the time difference T2-T1 is larger than a preset programmable threshold Tthreshold the blood is considered thick 870. If the time difference T2−T1 is less than a preset programmable threshold Tthreshold the blood is considered thin 880. This simple flow chart is presented here to describe the invention. In actual implementation the time and voltage is qualified with additional thresholds.

FIG. 9 shows an exemplary flow diagram for measuring blood constituents and the density of blood constituents 900. The process described herein is used to determine various types of blood constituents as they are separated through the chromatography process and the density of the separated blood constituents using the electrical quantity measurement techniques in relations to FIG. 7 and FIG. 8. At the beginning of the process reset the microprocessor initial states 910. Place the conductive strips responsible for creating a closed loop electrical circuit close 920 with small separation between them, the closeness is dictated by solvent flow speed and quantities of blood constituents. For better result the spacing between the conductor strips needs to be smaller than the band of the separated blood constituents for proper identification of blood constituents. A larger separation will average out multiple blood constituents. This separation is programmable so that various measurement objectives can be achieved. Start the chromatography test by putting a blood sample in the chromatography paper at the point of origin and couple the chromatography paper with the solvent container by dipping its base end in the solvent to start the chromatography action 930. Detect and measure the duration of voltage variations, ΔTi, i=1, 2, . . . , N and magnitude of the voltage variations ΔEi, i=1, 2, . . . N 940. Here we interchangeably use current, voltage divided by a fixed resistance, and voltage to measure blood constituents and their densities to generalize it in electrical terms. Compare duration of current variations at around a fixed level, ΔTi, i=1, 2, . . . , N, and magnitude of current variation at around a fixed level, ΔEi, i=1, 2, . . . N to a predefined reference mask 950. The mask can be programmed in the microprocessor as necessary. Record the degrees of deviation between measured and reference ΔT and ΔE 960, where E can be current or voltage as described earlier. Degrees of deviation between measured and reference ΔT and ΔE is reported as density variation and variation in polarity in step 960. Presence of extra ΔT and ΔE that does not match with the programmable mask is reported; similarly absence of ΔT and ΔE that does not match with the programmable mask is reported 970. The degree of deviation from the mask defines how much different is the measured data from the reference data.

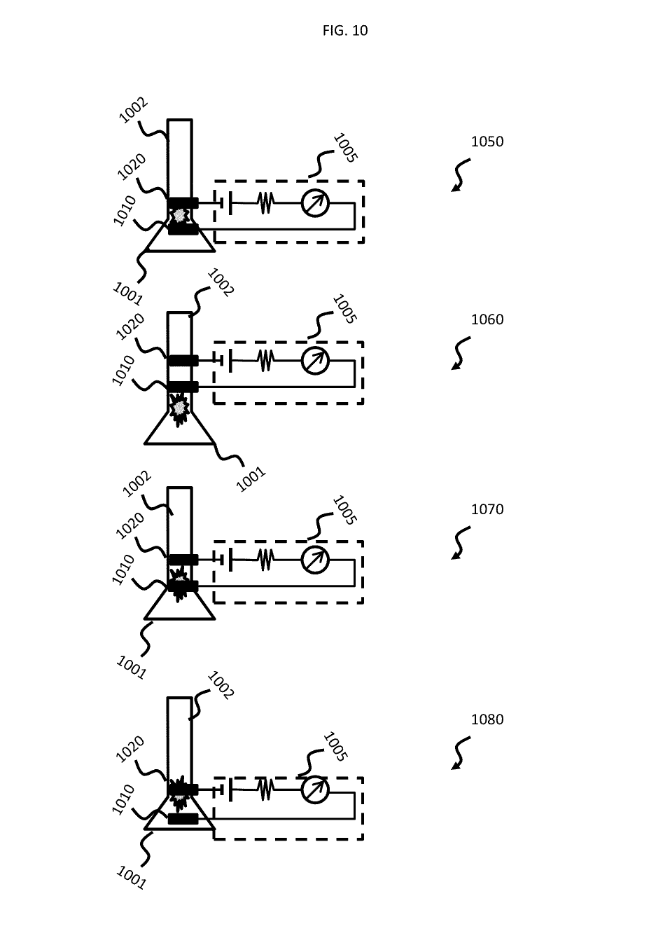

FIG. 10 shows various options to create the closed loop circuit such that variable resistance embodies different segments of the blood activities. A connection configuration determines the variable resistance behavior. The electrical circuit with the conductor connectors, voltage source, optional current limiting resistor, and optional current meter 1005 is configured for various connection modes. In one embodiment of this connection mode 1050 the conductor strips 1010 and 1020 wraps around the blood sample and the variable resistor is formed by the depleting blood constituents as the chromatography process progresses where solvent removes different constituents from the sample base and the remaining blood sample constituents offers the resistance that varies over time. In another embodiment of the invention the electrical circuit 1005 is placed away from the blood sample and the conductor strips 1010 and 1020 is placed in the path of the solvent 1002 away from the base 1001 where the variable resistance is created for the closed loop circuit by the blood constituents separated by the chromatography process over time. In another embodiment of the invention 1070 the electrical circuit 1005 is configured to be placed such that one conductor strip 1010 is on the blood sample and the other conductor strip is in the solvent path 1002 so that variable resistance is composed of the blood sample that is depleting through the chromatography process in the point of blood application origin and blood sample building up in the path of the solvent head 1002 and thus creating a variable resistance path. Blood spreading away from the solvent head 1002 is another part of the present invention. In this embodiment of the present invention 1080 one end of the conductor strip 1010 is placed between the bottom of the chromatography base and the blood sample and the other end of the conductor strip 1020 is placed on the blood sample or between the blood sample and the upward path of the solvent end 1002. The variable resistance is created by the blood constituent's variation between the two ends of the conductor strips 1010 and 1020.

FIG. 11 illustrates another embodiment of the present invention where blood thickness is measured from the electrical characteristics variation of the blood sample over time due to blood coagulation over time. In one embodiment 1150 the blood sample 1101 is placed in a blood sample holding strip, known as blood sample receptor, wherein at least two conductor strips connects the blood sample on at least two points in the blood sample. The electrical circuit 1005 monitors the electrical characteristics variation as illustrated in the embodiments in FIG. 6. The degrees of electrical variation over time are measured and the degrees of deviation from a pre defined variation mask indicate blood thickness variation from normal. In another embodiment of the present invention 1160 the blood sample 1101 is fed in to a container 1102. In this embodiment of the present invention the container is a capillary tube without limiting other options for other forms of containers. The container can be a test tube. The container can be an appropriate container used by one skilled in the art. The container 1102 has two or more conductor strips that make contact with the blood sample. The ends of two or more such metal strips are connected to circuit 1005. The container can be static and let blood coagulate inside it and the variable resistance effect of the blood during coagulation is evaluated by the circuit 1005 that is coupled to measurement means that includes measuring current through the closed loop circuit, measuring voltage across the conductor connector strips, measuring voltage across the fixed resistance in the circuit, or by means known by one skilled in the art by modifying the circuit. In another embodiment of the present invention the blood holding container 1102 is rotated across vertical axis 1140, across horizontal axis 1130, shake, or any combination of them. The variable resistance is created within a blood sample that is added with a chemical called procoagulant that promotes blood clot. A continuous blood sample between at least two electrical contacts offers certain electrical resistance. As blood clotting progresses after being treated with procoagulant the electrical resistivity property of blood sample changes. Thereby changes effective current flow through the blood sample if it is an element in the path of an electrical circuit. As blood clotting progresses the electrical characteristics of blood changes. In thin blood the rate of change electrical characteristics is slow. In thick blood the rate of change of electrical characteristics of blood is fast. Upon comparing this rate of change with normal blood rate of change of electrical characteristics the blood thickness characteristics is determined. For the purpose of this description we interchangeably use the electrical characteristics to refer to resistance, current, voltage, and conductance. The blood sample placed within a capillary where the capillary is a blood receptor that receives blood sample. The variable resistance between two or more electrical contacts changes as blood is treated with procoagulant wherein blood starts to clot and blood concentration continues to change and the blood sample electrical properties continue to change over time until it stops changing. The time when the blood variable resistance starts to change and stops changing is a quantitative measure of the blood thickness level. In another embodiment of the present invention the blood resistance change difference over a time window determines the thickness level of the blood where the difference in change of resistance is programmable and the time window is also programmable.

In this specification the electrical measurements includes variable resistance effect up on evaluating one or more parameters in the closed loop circuit that includes current through the closed loop circuit, variations in voltage measurement across the conductor strips, variation in the voltage measurement across the fixed resistance, or by other means as one skilled in the art might readily modify the embodiments of the present invention to evaluate the effects of variable resistance.

For explanation purposes we have used chromatography paper as an example to explain the spirit of the invention where electrical means used to detect the concentration of a substance and the density of a substance. But this invention is not limited to chromatography paper and extended to any martial that can offer variable resistance can be used to fulfillment the spirit of this invention.

The spirit of the invention is not limited to blood, and material that offers variable resistance characteristics falls within the scope of the invention.

For the purpose of this description the terms resistance and impedance are interchangeable to indicate the obstruction offered in current flow. For the purpose of the description the conductor strip, the metal conductor strip, the metal contacts, the electrical contacts, connector and similar wording is used interchangeably. The electrical contacts are used to form the closed loop circuit connection where the variable resistance path is created by the constituents of blood and other chemicals in the path. An electrical contact also known as connection is created by a conductive material connecting to the chromatography paper or any surface over which blood is creating a variable resistance path.

For the purpose of description the contact between the chromatography paper, usually referred to as chromatography, is cited as conductive metal strip, conductor strip, metal strip, electrical contact and similar interchangeably that can be any electrical contact, such as a wire, wire mesh, or any contact material.

The present invention addresses a method and apparatus for detecting blood thickness or thinness levels, for brevity often blood thickness is used in the specification to address both thickness and thinness.

Additionally, reference herein to “one embodiment”, “in another embodiment “or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the terms “implementation” and “example.”

In this specification the terms “couple,” “coupling,” “coupled,” “connect,” “connecting,” or “connected,” refer to a connection between two or more elements.

It is understood that various changes in the details, materials, and arrangements of the parts which have been described and illustrated in order to explain the nature of this invention may be made by those skilled in the art without departing from the scope of the invention as expressed in the following claims.

It is understood that the flowchart stated in explaining the invention can be implemented by a microprocessor, a digital state machine, in graphics and display unit, or through other user interface mechanism.

We claim:

1. An apparatus for blood characterization, comprising:
at least one blood sample receptor;
a plurality of electrical contacts connected to said receptor; and
means for creating a variable resistance between two or more said electrical contacts.

2. The apparatus of claim 1 wherein said receptor is a chromatography paper treated with anticoagulant.

3. The apparatus of claim 1 wherein a plurality of said electrical contacts coupled to said blood sample on said receptor where said blood sample is treated with procoagulant.

4. The apparatus of claim 1 wherein a voltage source connected across at least two electrical contacts offers means for measuring said variable resistance.

5. The apparatus of claim 1 further comprising:
a multiplexer input coupled to at least one electrical contact attached to said receptor;
a multiplexer input selector to select one said electrical contact at said multiplexer output;
a voltage source connected to said multiplexer output;
an electrical contact attached to said receptor on one side and said voltage source on another side; and
means for measuring a plurality of variable resistance value and their time of occurrences.

6. The apparatus as in claim 1 wherein said variable resistance is compared against a reference mask to determine the degree of blood characteristics deviation.

7. The apparatus as in claim 1 wherein said variable resistance offers means for determining blood thickness as said variable resistance changes in a time window.

8. The apparatus of claim 1 wherein said variable resistance offers means for determining blood constituent density as well as absence as well as presence of certain blood constituents.

9. The apparatus as in claim 1 wherein said receptor solvent end base is wider than the body of the receptor whereby wide solvent end base allow more surface area to said solvent to flow through blood sample for improved blood constituent separation.

10. The apparatus as in claim 1 wherein means for connecting the electrical contacts connection orientation with said receptor determines variable resistance behavior.

11. The apparatus as in claim 1 wherein plurality of time and plurality of electrical quantities are determined with a processing unit.

12. A method for characterizing blood, comprising the steps of:
placing blood sample on at least one blood sample receptor;
connecting a plurality of electrical contacts with said receptor; and
creating a variable resistance between two or more said electrical contacts by altering electrical properties of said blood constituents concentration.

13. The method of claim 12 further comprising the step of treating said receptor with anticoagulant.

14. The method of claim 12 further comprising the step of connecting a plurality of electrical contacts such that the electrical contacts are touching the blood sample on the receptor.

15. The method of claim 12 further comprising the step of adding procoagulant to the blood sample to initiate blood clotting.

16. The method of claim 12 wherein a closed loop electrical circuit is produced by connecting at least a battery across two electrical contacts for measuring said variable resistance using current voltage relationship.

17. The method of claim 12 further comprising the step of determining the degree of measured blood deviation from at least one reference mask by recording a plurality of variable resistance values and their time of occurrences and comparing them against said mask.

18. The method of claim 12 wherein quantification of blood thickness is accomplished by measuring the time of variable resistance change from the first value to a plurality of subsequent values in a pre defined time window.

19. The method of claim 12 where quantification of blood constituent density is accomplished by measuring the value of variable resistance in pre defined time window.
